(19) United States
(12) Patent Application Publication
(10) Pub. No.: US 2022/0041142 A1
(43) Pub. Date: Feb. 10, 2022

(54) Breakaway Trailer Switch and Alarm

(71) Applicant: Amerawhip, Inc., Indianapolis, IN (US)

(72) Inventor: John Clifford, Indianapolis, IN (US)

(21) Appl. No.: 17/359,706

(22) Filed: Jun. 28, 2021

Related U.S. Application Data
(60) Provisional application No. 63/045,242, filed on Jun. 29, 2020.

(51) Int. Cl. B60T 7/20; G07C 5/08; B60R 16/033

(52) U.S. Cl. CPC B60T 7/20; G07C 5/0825; B60Q 5/005; B60R 16/033; G07C 5/0833

(57) ABSTRACT

This disclosure describes a breakaway switch comprising a housing connected to a trailer. An alarm sensor is positioned within the housing. The alarm sensor is operatively connected to a power source, is operatively connected to an alarm, and is operatively connected to at least one trailer brake. A cable having a first end and a second end, wherein the first end is connected to a tow vehicle and the second end is removably connected to the housing. When the second end is separated from the housing, the alarm sensor sends a signal to an audible or optical alarm to notify an operator that the trailer has separated from a tow vehicle, and the alarm sensor sends a signal to the at least one trailer brake to cause the at least one trailer brake to activate.

### PRIORITY CLAIM

The present application claims priority to U.S. provisional patent application No. 63/045,242, filed Jun. 29, 2020, titled “Breakaway Trailer Switch and Alarm.” The entire content of the identified provisional patent application is hereby incorporated by reference.

### FIELD OF DISCLOSURE

This disclosure relates generally to breakaway switches, and more particularly to a trailer breakaway switch comprising optical and/or audible alarms. Adding an alarm or signal to indicate whether the electric brake's safety breakaway pin has been unintentionally or unexpectedly removed is needed. An alarm or signal means a light or sound to alarm or signal a problem in a vehicle. An actuated braking system that remains unnoticed can lead to safety issues such as a fire, due to prolonged high current on the brake system.

### BACKGROUND

Braking systems have been used on vehicles such as trucks, trailers, and the like. Breakaway switches have been used on trailers to help stop them if they become separated from the towing vehicle. Breakaway braking systems have been shown in U.S. Pat. Nos. 3,907,071 and 4,052,695. These systems typically have an auxiliary battery mounted on the trailer which activates the electric trailer brakes when the trailer separates from the towing vehicle. U.S. Pat. No. 3,681,551 describes a disconnect safety switch used in a breakaway braking system.

Known breakaway switches suffer from several design deficiencies. Presently, breakaway switches are mechanical devices that typically use a nonconductive mechanism to mechanically separate the contacts of the switch. The known art does not provide an audible or optical alert to the operator of the towing vehicle upon unintentional activation of the breakaway switch. It is desirable to provide a breakaway switch that overcomes the problems discussed above and notifies the vehicle operator in the event of unintended decoupling of the trailer from the towing vehicle.

### SUMMARY

One aspect of the present invention is an alarm or signal installed on a recreational vehicle or any other type of trailer. The system comprises electrically actuated brakes and a breakaway switch to provide an optical or audible alert of unintentional activation while in motion or while stationary. The alert or alarm remains activated when the breakaway system is actuated.

An optical alarm or signal lamp may be mounted on or in the breakaway switch, in or on the tow vehicle in view of the driver. The optical alarm or signal lamp may be positioned in view of the driver of the tow vehicle. Alternatively, the alarm or signal may be viewable by the driver of the tow vehicle through the interior rearview mirror or outside rearview mirror of the tow vehicle. The optical alarm or signal may be incorporated into the breakaway switch or installed as a separate alarm or signal lamp placed adjacent to the switch in a visible location. The optical alarm or signal may be steady burning or flashing. The optical alarm or signal color may be illuminated white or any other desired color.

The audible alarm or signal may be located at the front of the recreational vehicle to permit the driver to hear the alarm or signal in the tow vehicle while in motion on the highway or while stationary. The audible alarm or signal device may be positioned in the interior of the tow vehicle. The audible alarm or signal device may be located within the breakaway switch or adjacent thereto on the trailer. The audible alarm or signal may have a sound level of a minimum of 40 decibels. The audible alarm or signal comprises a sound tone that differs from the sound tone provided with emergency vehicle sirens. An audible sound level ensures the driver will hear the alarm or signal should the breakaway switch become actuated while the tow vehicle and trailer combination is in use.

The breakaway switch may have a warning label affixed in a visible location near (e.g., withing about 24 inches) the breakaway switch. The warning label may state substantially as follows: “This switch is for emergency use only. The lanyard pin must always be fully inserted in the breakaway switch. The breakaway switch is not intended for and is not to be used as a parking brake feature. Can lead to break failure or a fire which could result in death or injury.”

### BRIEF DESCRIPTION OF THE DRAWINGS

FIG. 1 shows a schematic view of the tow vehicle and a trailer connected thereto.

FIG. 2 shows a schematic view of the trailer with a breakaway switch mounted thereon.

FIG. 3 shows an exploded view of the breakaway switch connected to power source and trailer brakes.

FIG. 4a shows a top view of the cable, plug and housing.

FIG. 4b shows a perspective view of the cable and plug.

FIG. 5a shows the electrical wiring schematic for a breakaway switch with audible and optical alarms.

FIG. 5b shows electrical wiring schematic for a switch with a blown fuse alarm.

FIG. 6a shows a top view cross section of the switch with alarm.

FIG. 6b shows a top view of the switch with its cover removed.

FIG. 7a shows a perspective view of the switch with an LED bulb.

FIG. 7b shows a perspective view the switch with an audible alarm/speaker.

### DETAILED DESCRIPTION

Systems, devices, or methods disclosed may include one or more of the features structures, methods, or combination thereof described. For example, a device or method may be implemented to include one or more of the features and/or processes described herein. Such device or method need not include all the features and/or processes described but may be implemented to include selected features and/or processes that provide useful structures and/or functionality. Various modifications and additions can be made to the disclosed embodiments. The scope of the present disclosure is not limited by the embodiments described but is defined by the claims set forth below and equivalents thereof.

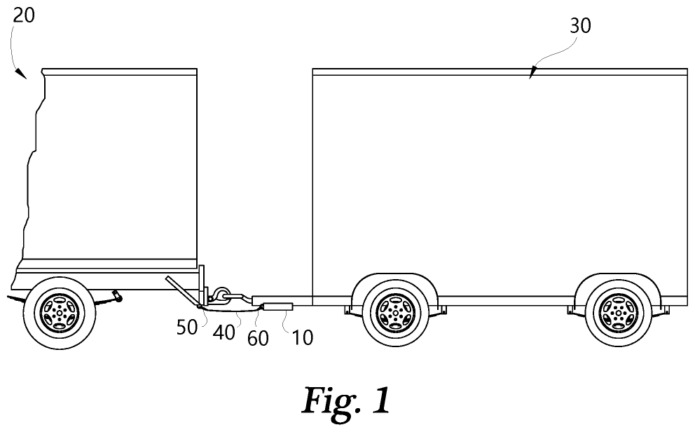

Referring to FIG. 1, a breakaway switch 10 is positioned on a trailer 30 and operatively connected to a tow vehicle 20. Trailer 30 is depicted as a recreational vehicle. However, the disclosed invention can be used with any type of trailer 30. The switch 10 operates when towed trailer 30 separates from the tow vehicle 20.

A cable 40 is operatively and removably connected to the tow vehicle 20 and the breakaway switch 10. The cable 40 may be made from steel, aluminum, plastic, rubber, or other suitable material that is resistant to corrosion, moisture, dirt, and the like. The cable 40 has a first end 50 and a second end 60. First end 50 is removably connected to the tow vehicle 20 at a position other than the hitch or electrical trailer break connection (not shown). The second end 60 comprises a plug 62 sized to be removably inserted into female receptor 12 of the breakaway switch 10.

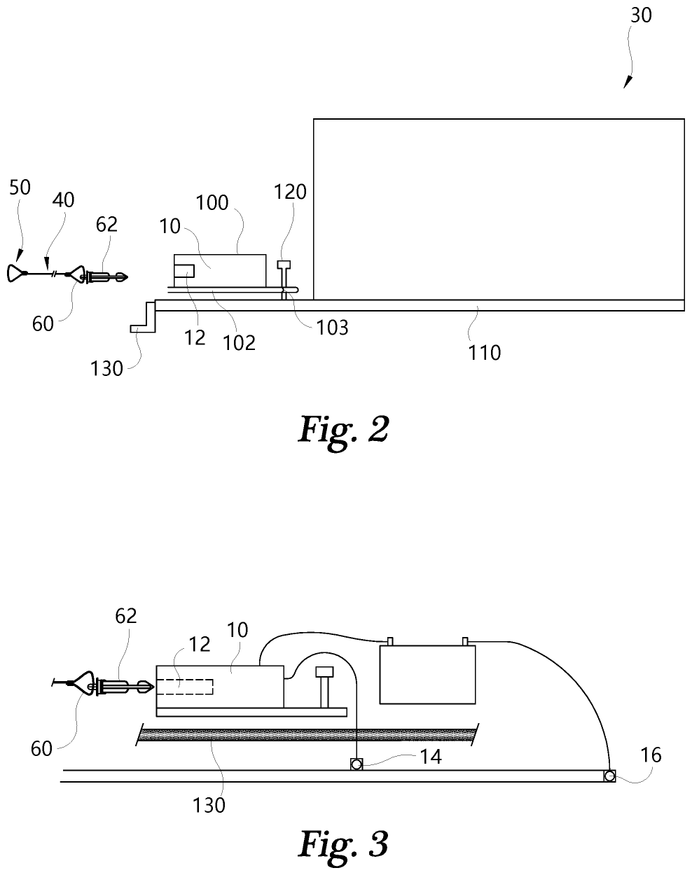

Referring to FIG. 2, breakaway switch 10 comprises a housing 100. Housing 100 may be formed from a metal, plastic, or other suitable material known in the art. The housing 100 may be removably attached to bracket 102. The breakaway switch 10 is mounted on trailer frame no preferably in a horizontal plane as close to the trailer hitch 130 as possible. The cable 40 connection between the tow vehicle 20 and trailer 30 should be free of strain and obstacles interfering. When the cable 40 is connected to tow vehicle 20 and trailer 30, the tow vehicle 20 must be able to make complete right and left maneuvers without straining the cable 40. That is, the tow vehicle 20 must be able to maneuver from full left steering wheel lock to full right steering wheel lock without exerting force on cable 40 that would cause second end 60 to separate from breakaway switch 10.

The breakaway switch 10 is preferably bolted to the trailer frame 11o with bolt 120 having a minimum diameter of ¼ inch. The bracket 102 has hole 103 through which bolt 120 passes to secure switch 10 to trailer 30. Bolt 120 withstands up to 75 pounds of force while remaining capable of allowing the switch 10 to rotate around the longitudinal access of the bolt 120. That allows the switch 10 to retain cable 40 as the vehicle 20 makes full left or right turns. After the breakaway switch 10 is connected to trailer frame 110, the plug 62 should be removed from female receptor 12 of switch 10 to confirm the brakes 130 engage.

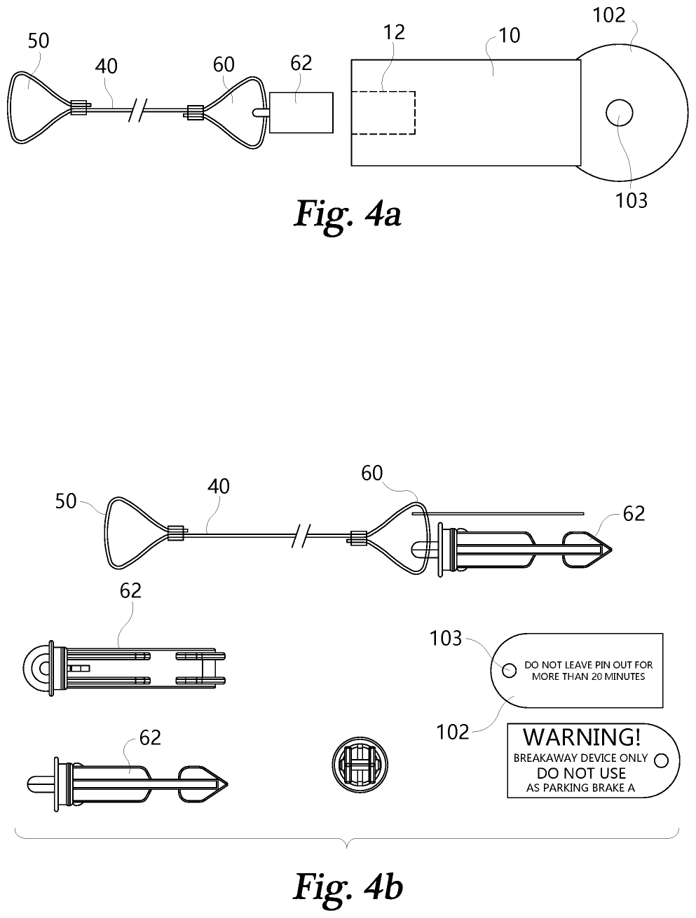

Referring to FIG. 3, breakaway switch 10 receives power from a power source 40. In a preferred embodiment, power source 40 is a 12-volt battery such as commonly used for vehicles. A person of ordinary skill in the art will appreciate that other types of power sources 40 may be used without departing from the scope of the invention disclosed and claimed. Breakaway switch 10 is operatively connected to trailer brake 130. Trailer brake 130 receives power from power source 40 or an alternate power source 42. Switch 10 is operatively connected to trailer break positive lead 14. Power source 40 is operatively connected to trailer break ground 16.

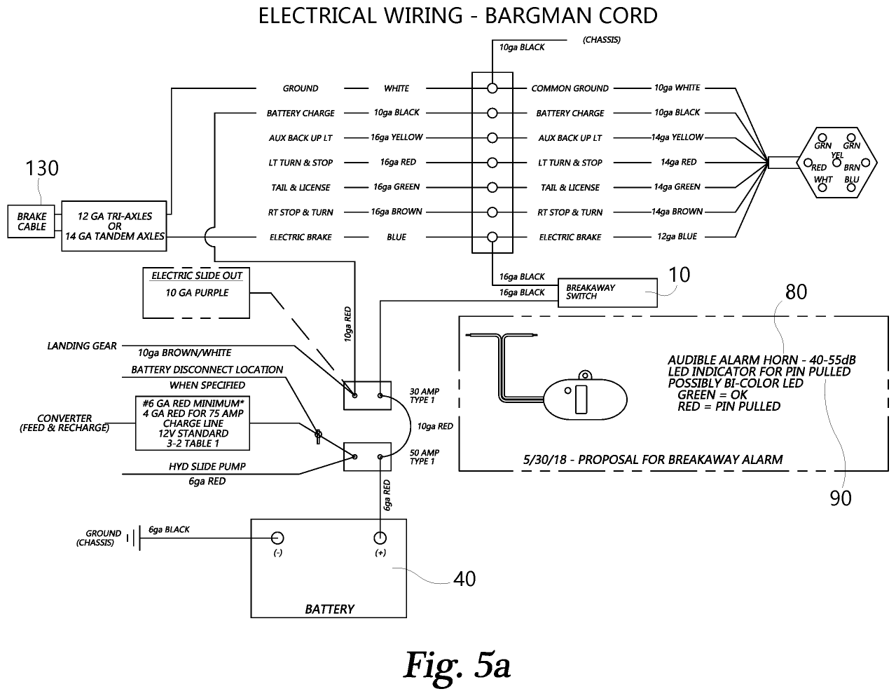

Referring to FIG. 4a, a top view of the switch 10 is shown in relation to the cable 40. First end 50 attaches to the tow vehicle 10 (not shown). Second end 60 connects plug 62 to cable 40. Switch housing 100 has female receptor 12 to receive plug 62. Housing 100 also has bracket 102 with hole 103 to secure the switch 10 to the trailer 30 not shown. FIG. 4b shows the cable 40 having first end 50 and second end 60. Second end 60 secures plug 62 to cable 40.

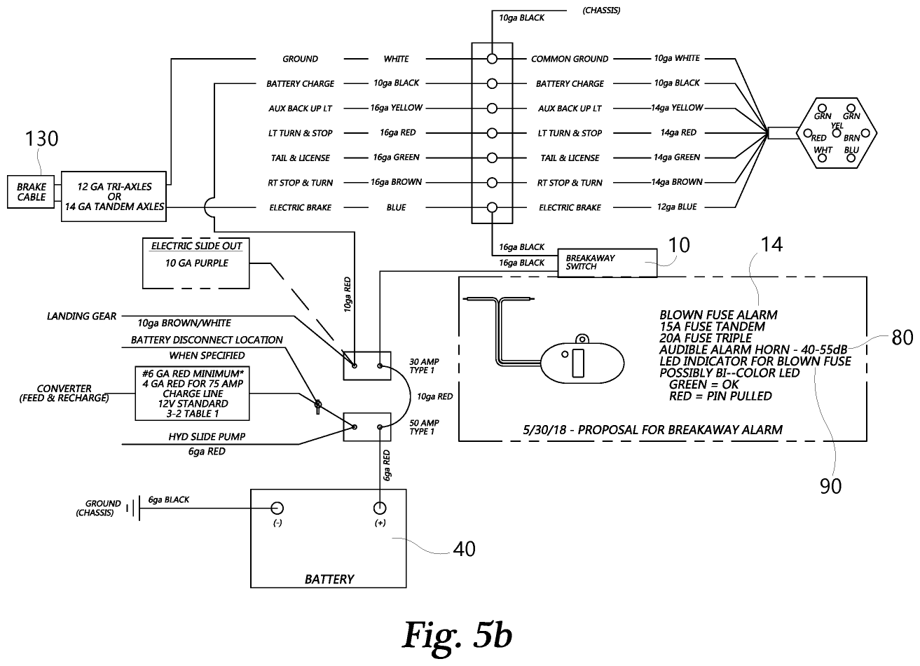

Figure Sa shows the electrical wiring schematic for one version of the breakaway switch 10 with alarm. This embodiment shows an audible alarm horn 80, an optical alarm 90 as an LED indicator. The alarms activate when plug 62 is moved from the female receptor 62. The breakaway switch 10 is connected to a power source 40 and to trailer brakes 130. FIG. 5b shows the electrical wiring schematic for another version of the invention where in the switch 10 further comprises a blown fuse alarm 14 in addition to audible alarm 80 and optical alarm 90. Audible alarm 80 and/or optical alarm 90 activate if blow fuse alarm 14 activates.

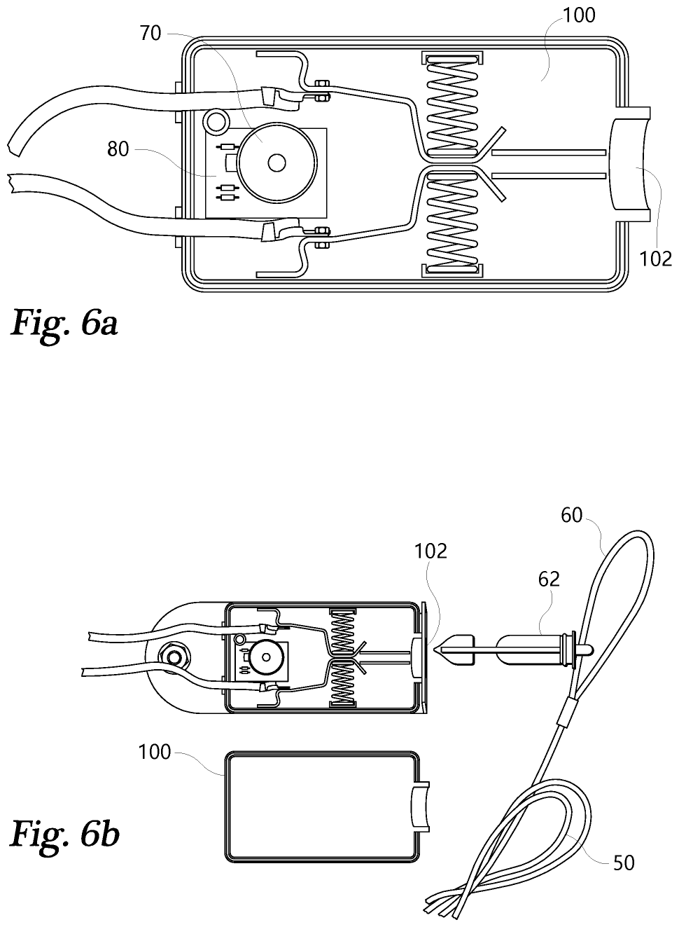

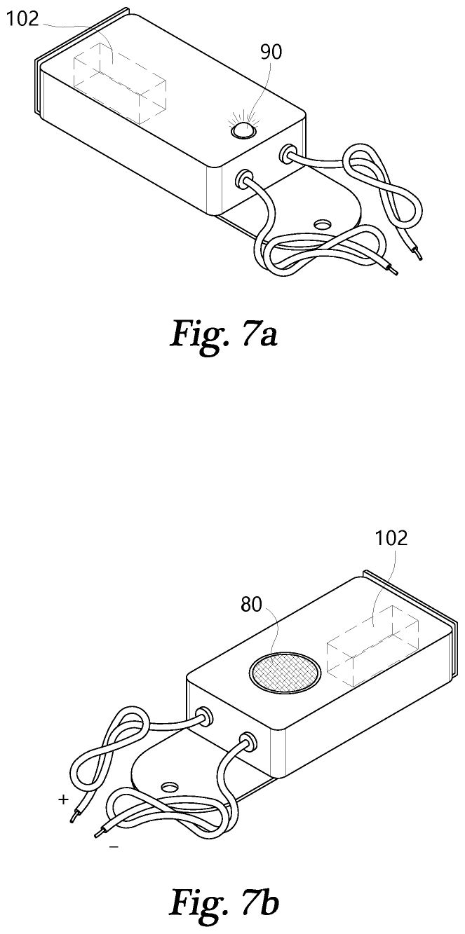

FIG. 6a shows a cutaway view of the housing 100. Housing 100 has female receptor 102, alarm sensor 70, and audible alarm 80. FIG. 6b shows housing 100 cutaway with female receptor 102 and plug 62 secured by second end 60 of cable 40. Alarm sensor 70 may be a mechanical device to close electric circuit to activate audible alarm 80 and/or optical alarm 90. Alternatively, alarm sensor 70 may be an electrical device to close electric circuit to activate audible alarm 80 and/or optical alarm 90.

Breakaway switch 10 has an alarm sensor 70, operatively connected to audible alarm 80, optical alarm 90, or both 80, 90. Breakaway switch 10 may contain one or more fuses 140. Should the trailer 30 separate from tow vehicle 30, cable 40 pulls away from trailer 30 such that plug 62 disconnects from female receptor 12 of the breakaway switch 10. When the plug 62 disconnects from female receptor 12 of breakaway switch 10, an electrical connection closes and triggers the alarm sensor 70. The alarm sensor 70 is thereby activated. The alarm sensor 70 is operatively connected to an optical alarm 80, an audible alarm 90, or both. Upon separation of the cable 40 from the breakaway switch 10, the switch 10 will close the electrical circuit from the trailer battery 100 to the trailer brakes 110 and cause the trailer brakes 110 to be applied. For the breakaway switch 10 to operate properly, the trailer battery 100 must be sized to the trailer brakes 110.

The audible alarm 80 comprises a mechanism to create a sound of sufficient volume to alert the user of the tow vehicle 20 that that which that the breakaway switch 10 has activated. A preferred embodiment uses a sound transducer as the audible alarm 80. In a preferred embodiment, audible alarm 80 produces sound of at least 40 decibels. Audible alarm 80 may produce a continuous or intermittent audible sound to alert the user that the switch 10 has activated.

Audible alarm 80 may be positioned in switch 10, adjacent switch 10, or on housing 100. In an alternative embodiment, audible alarm 80 may be positioned in the tow vehicle 20 to alert the driver that the switch 10 has activated. Audible alarm 80 may be hard wired to alarm sensor 70. Alternatively, audible alarm 80 may be wirelessly connected to alarm sensor 70. A person of ordinary skill in the art will appreciate how to operatively connect alarm sensor 70 and audible alarm 80 using known means be they wired or wireless.

The optical alarm 90 is operatively connected to alarm sensor 70. As described above, when cable 40 disconnects from breakaway switch 10, alarm sensor 70 senses an electrical alarm or signal indicating an alarm needs to be triggered. Optical alarm 90 may be operatively connected to alarm sensor 70 with wires, other electrically conductive material, or wirelessly, such as Bluetooth or RFID. Alarm sensor 70 sends an electrical alarm or signal to optical alarm 90 and to trailer brakes 130 to engage brakes 130.

The optical alarm 90 may be positioned on the housing 100 or proximate thereto on trailer 30. The optical alarm 90 is to be positioned to be visible by the driver of the tow vehicle 20 using mirrors attached thereto. Alternatively, the optical alarm 90 may be positioned in the tow vehicle 20 within eyesight of the operator. The optical alarm 90 may comprise an LED, an incandescent light, or other suitable illumination source. The optical alarm 90 may display a color such as green when the breakaway switch 10 is properly connected. The optical alarm 90 may display a color such as red or yellow when the breakaway switch 10 disconnects from cable 40. A person of skill in the art will recognize that any suitable color may be used for the optical alarm and that the optical alarm 90 may be continuous or intermittent.

I claim:

1. A breakaway switch comprising:
a. a housing connected to a trailer, wherein an alarm sensor is positioned within the housing, the alarm sensor being operatively connected to a power source, being operatively connected to an audible alarm, and being operatively connected to at least one trailer brake; and
b. a cable having a first end and a second end, wherein the first end is connected to a tow vehicle and the second end is removably connected to the housing, wherein when the second end is separated from the housing the alarm sensor sends a signal to the audible alarm to activate to notify an operator that the trailer has separated from a tow vehicle and the alarm sensor sends a signal to the at least one trailer brake to cause the at least one trailer brake to activate.

2. The breakaway switch of claim 1 wherein the power source is a battery.

3. The breakaway switch of claim 1 wherein the audible alarm is positioned in the housing.

4. The breakaway switch of claim 1 wherein the audible alarm is positioned proximate the housing on the trailer.

5. The breakaway switch of claim 1 wherein the audible alarm is positioned in a tow vehicle.

6. The breakaway switch of claim 1 the audible alarm is a sound transducer.

7. A breakaway switch comprising:
a. a housing connected to a trailer, wherein an alarm sensor is positioned within the housing, the alarm sensor being operatively connected to a power source, being operatively connected to an optical alarm, and being operatively connected to at least one trailer brake; and
b. a cable having a first end and a second end, wherein the first end is connected to a tow vehicle and the second end is removably connected to the housing, wherein when the second is separated from the housing the alarm sensor sends a signal to the optical alarm to activate the optical alarm and notify an operator that the trailer has separated from a tow vehicle and the alarm sensor sends a signal to the at least one trailer brake to cause the at least one trailer brake to activate.

8. The breakaway switch of claim 7 wherein the power source is a battery.

9. The breakaway switch of claim 7 wherein the optical alarm is positioned on an outer surface of the housing.

10. The breakaway switch of claim 7 wherein the optical alarm is positioned proximate the housing on the trailer.

11. The breakaway switch of claim 7 wherein the optical alarm is positioned in a tow vehicle.

12. The breakaway switch of claim 7 wherein the optical alarm is a light source.

13. The breakaway switch of claim 12 wherein the light source is a light emitting diode.

14. A breakaway switch comprising:
a. a housing connected to a trailer, wherein an alarm sensor is positioned within the housing, the alarm sensor being operatively connected to a power source, being operatively connected to an audible alarm and an optical alarm, and being operatively connected to at least one trailer brake; and
b. a cable having a first end and a second end, wherein the first end is connected to a tow vehicle and the second end is removably connected to the housing, wherein when the second is separated from the housing the alarm sensor sends a signal to the audible alarm and to the optical alarm to activate the audible alarm and to activate the optical alarm to notify an operator that the trailer has separated from a tow vehicle, and the alarm sensor sends a signal to the at least one trailer brake to cause the at least one trailer brake to activate.

15. The breakaway switch of claim 14 wherein the power source is a battery.

16. The breakaway switch of claim 14 wherein the audible alarm is positioned in the housing and the optical alarm is positioned on the housing.

17. The breakaway switch of claim 1 wherein the audible alarm and the optical alarm are positioned proximate the housing on the trailer.

18. The breakaway switch of claim 1 wherein the audible alarm and the optical alarm are positioned in a tow vehicle.
